(19) United States
(12) Patent Application Publication
(10) Pub. No.: US 2017/0082202 A1
(43) Pub. Date: Mar. 23, 2017

(54) SEALS FOR NATURAL GAS COMPRESSOR

(71) Applicant: Intellectual Property Holdings, Inc., Cleveland, OH (US)

(72) Inventors: Dan T. Moore, Cleveland Heights, OH (US); Matt Raplenovich, Avon Lake, OH (US); Tongzhai Gao, Euclid, OH (US)

(21) Appl. No.: 15/267,723

(22) Filed: Sep. 16, 2016

Related U.S. Application Data
(60) Provisional application No. 62/219,891, filed on Sep. 17, 2015.

(51) Int. Cl. F16J 15/3284; F04B 53/14; F04B 39/12

(52) U.S. Cl. CPC F16J 15/3284; F04B 39/12; F04B 53/143; F15B 15/1447

(57) ABSTRACT

An exemplary reciprocating compressor includes a compression chamber enclosed by a cylinder and a piston. The piston includes a piston seal for sealing a gas in the compression chamber. The piston seal is formed of about 70 to about 90 percent by weight of a fluorinated polymer, about 2 to about 18 percent by weight of an organic filler, and about 2 to about 18 percent by weight of boron nitride.

### CROSS-REFERENCE TO RELATED APPLICATIONS

The present application claims the benefit of U.S. Provisional Application Ser. No. 62/219,891, filed on Sep. 17, 2015, titled SEALS FOR COMPRESSED NATURAL GAS, the disclosure of which is incorporated by reference in its entirety.

### TECHNICAL FIELD

The present invention relates generally to gas compressors, such as natural gas compressors, and more particularly, piston seals for use in a reciprocating natural gas compressor.

### BACKGROUND OF THE INVENTION

Rotary and reciprocating gas compressors are known. A reciprocating compressor having a piston, crankshaft, housing, and piston seals can be used to compress natural gas to pressures suitable for storage in a vehicle. The seals are often needed for safe and reliable operation of high pressure natural gas compressors, such as those used to refuel natural gas vehicles. Natural gas in vehicles may be compressed up to 3,600 psi, is flammable, and must be contained at all times. Furthermore, lubricants that may improve the lifetime of components in the natural gas compressor often cannot be used as they may foul the vehicle fueling system.

The piston seals of the compressor form a seal between the piston and the cylinder wall. Seals can mechanically wear down over time as they are pressed against the cylinder wall by the piston and moved back and forth across the cylinder wall. Heat may also build up in the compressor during use, further decreasing lifetime of the piston seal.

### SUMMARY

Exemplary embodiments of natural gas compressors are disclosed herein.

An exemplary reciprocating compressor includes a compression chamber enclosed by a cylinder and a piston. The piston includes a piston seal for sealing a gas in the compression chamber. The piston seal is formed of about 70 to about 90 percent by weight of a fluorinated polymer, about 2 to about 18 percent by weight of an organic filler, and about 2 to about 18 percent by weight of boron nitride.

### BRIEF DESCRIPTION OF THE DRAWINGS

These and other features and advantages of the present invention will become better understood with regard to the following description and accompanying drawings in which:

FIG. 1 is a cross-sectional view of a cylinder assembly for a gas compressor;

FIGS. 2A and 2B are a diagrams illustrating the interaction of a seal material and a rough surface;

FIG. 3A is a front view of a wear tester;

FIG. 3B is a front view of a seal test sample for use in the wear tester of FIG. 3A;

FIG. 3C is a bottom view of a seal test sample for use in the wear tester of FIG. 3A;

FIG. 4A is a scanning electron microscope (SEM) image of an anodized aluminum surface before wear testing;

FIG. 4B is a graph showing energy dispersive spectroscopy (EDS) results for the anodized aluminum surface of FIG. 4A;

FIG. 5A is a SEM image of an anodized aluminum surface after 400 hours of wear testing;

FIG. 5B is a graph showing EDS results for the anodized aluminum surface of FIG. 5A;

FIG. 6A is a SEM image of a stainless steel surface before wear testing;

FIG. 6B is a graph showing EDS results for the stainless steel surface of FIG. 6A;

FIG. 7A is a SEM image of a stainless steel surface after 400 hours of wear testing;

FIG. 7B is a graph showing EDS results for the anodized aluminum surface of FIG. 7A;

FIG. 8 is a graph showing the weight retention of boron nitride filled polytetrafluoroethylene (PTFE) seal material over the course of wear testing;

FIG. 9 is a graph showing the weight retention of non-boron nitride filled polytetrafluoroethylene (PTFE) seal material over the course of wear testing;

FIG. 10 is a graph showing the weight retention of commercial polytetrafluoroethylene (PTFE) seal material over the course of wear testing;

FIG. 11 is a graph showing the weight retention of different seal materials after wear testing on anodized aluminum; and

FIG. 12 is a graph showing the weight retention of different seal materials after wear testing on stainless steel.

### DETAILED DESCRIPTION

Prior to discussing the various embodiments, a review of the definitions of some exemplary terms used throughout the disclosure is appropriate. Both singular and plural forms of all terms fall within each meaning.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements. “Physical communication” as used herein, includes but is not limited to connecting, affixing, joining, attaching, fixing, fastening, placing in contact two or more components, elements, assemblies, portions or parts. Physical communication between two or more components, etc., can be direct or indirect such as through the use of one or more intermediary components and may be intermittent or continuous.

Increasing the lifetime of a piston seal, that is, the length of time that a seal operates properly before requiring replacement, reduces maintenance costs for a gas compressor. In some applications, a 3,000 hour lifetime for the piston seal in a 3,600 psi compressor is desirable. The lifetime of the seal can be increased by reducing the mechanical wear experienced by the piston seal and the cylinder wall during operation of the gas compressor. Wear can be reduced by providing a piston seal with the following features: improved resistance to extrusion creep, the ability to conform to irregularities in the cylinder wall surface, the capacity to transfer friction-generated heat away from the seal-cylinder interface, and material that creates a lubricious transfer surface on the cylinder wall.

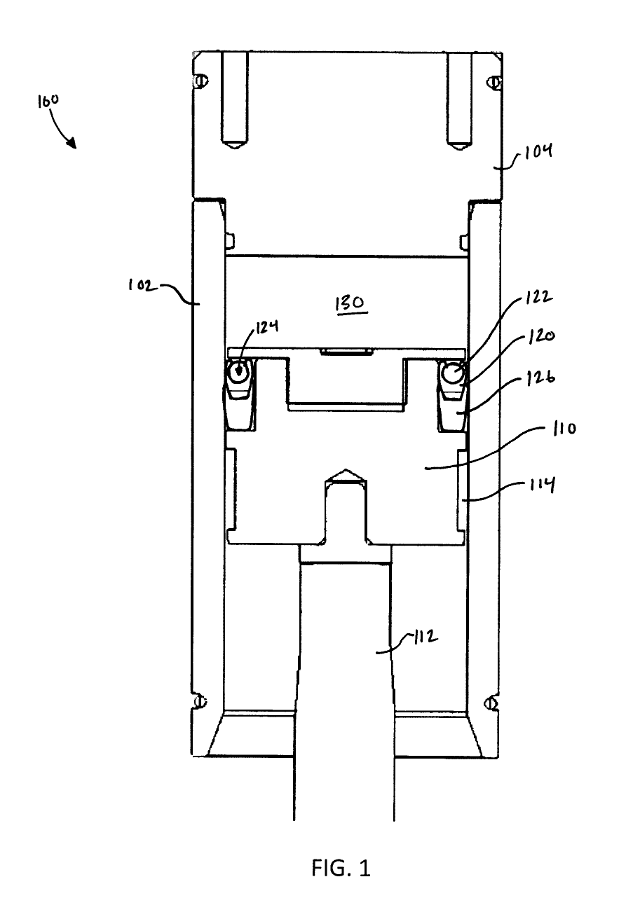

Referring now to FIG. 1, an exemplary gas cylinder assembly 100 for a compressor is shown. The gas cylinder assembly 100 can be used to compress natural gas or any other kind of gas. The cylinder assembly 100 includes a cylinder 102 and a piston 110 that moves up and down within the cylinder 102. A compression chamber 130 is formed by the cylinder 102, a head assembly 104, and the moveable piston 110. In some embodiments, the cylinder 102 is formed of an alloy of stainless steel or aluminum strong enough to withstand the pressures resulting from compression of natural gas up to, for example, 3,600 pounds per square inch (psi). A pushrod 112 connects the piston 110 to the drive shaft (not shown) of the compressor 100. The piston 110 may include a rider band 114 that provides a low friction interface between the piston 110 and the cylinder 102. As shown in FIG. 1, a piston seal 120 disposed above the rider band 114 on the outer diameter of the piston 110 provides a seal between the cylinder 102 and the piston 110 to prevent leakage from the compression chamber 130. While the seal 120 is shown in a reciprocal compressor for compressing natural gas, the seal 120 may be used with any type of compressor. In the illustrated embodiment the piston seal 120 is a spring-energized seal that includes a helical spring 122 disposed within a U-shaped annular groove 124 of the seal 120. However, other types of seals may be used to create a seal around the piston, such as, for example, one or more O-rings, seal rings, hydraulic seals, or other seals suitable for creating a seal on a moving surface, that is, a dynamic seal. In some embodiments, the U-shaped annular groove 124 of the seal 120 faces the compression chamber 130 so that the pressure of gasses inside the compression chamber 130 provides additional sealing force pressing the sides of the seal 120 against the cylinder wall 102. In some embodiments, a back-up seal 126 is provided below the piston seal 120 to provide mechanical support to the piston seal 120, thereby reducing extrusion of the seal 120 from repeated piston cycles.

In a reciprocating compressor, such as that shown in FIG. 1, the lifetime of the seal 120 is affected by the composition and surface texture of the cylinder 102. Tribological pairs, that is, pairings of seal and wall materials, can reduce wear of the seal 120 by reducing the friction between the seal 120 and the wall of the cylinder 102. In some embodiments, a portion of the seal material is transferred to the surface of the cylinder wall 102, thereby reducing friction and wear between the cylinder 102 and the seal 120.

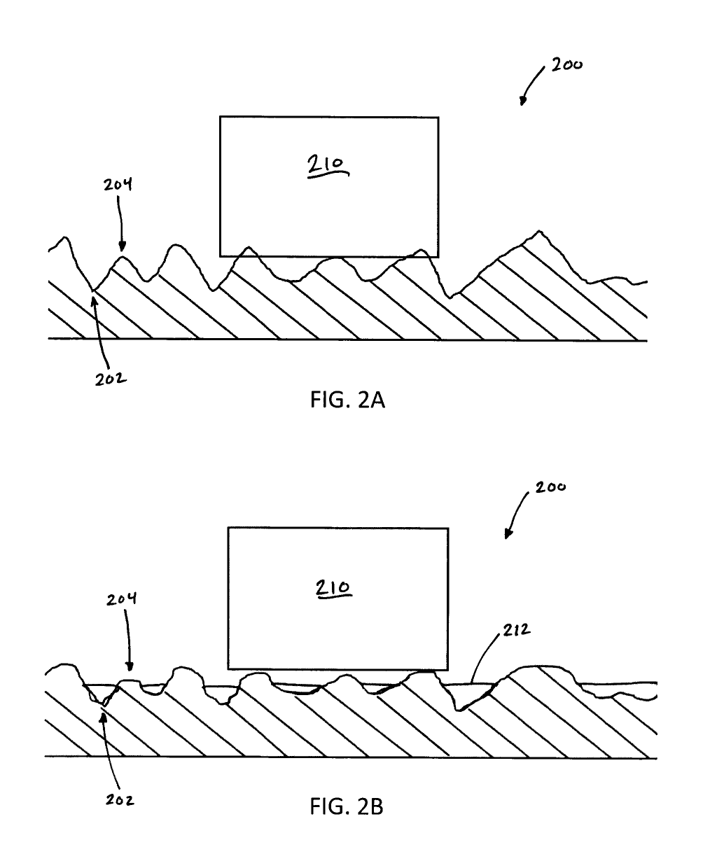

Referring now to FIGS. 2A and 2B, a diagram showing an enlarged view of the surface of an exemplary cylinder wall 200 is shown. A smooth surface finish on the cylinder wall reduces the wear on the piston seal, thereby increasing time between maintenance. Some amount of abrasion, however, helps reduce friction between the seal and cylinder by transferring seal material to the cylinder wall.

FIG. 2A illustrates a seal 210 engaging the cylinder wall 200. The cylinder wall 200 includes valleys 202 and peaks 204. The amplitude and frequency of the valleys 202 and peaks 204 determines the roughness of a surface. The surface roughness can be quantified by measuring the height of the valleys 202 and peaks 204 above an ideal surface and calculating the average height. FIG. 2B illustrates the valleys 202 of the wall 200 are filled with seal material 212 that has flaked off of the seal 210 as the seal material 210 is moved back and forth over the cylinder wall 200. The flaked off seal material 212 forms a thin barrier between the seal 210 and portions of the wall 200 that are covered. As shown, the peaks 204 are also reduced in height because of the repeated engagement between the wall 200 and seal 210. The reduction in height of the peaks 204 and the filling of the valleys 202 reduces the average depth of the valleys 202 and height of the peaks 204, thereby smoothing out the surface and decreasing its measured surface roughness. The filling of the valleys 202 with seal material 212 also reduces the amount of metal contacting the seal 210, further decreasing friction between the seal 210 and the cylinder wall 200.

In some embodiments, the seal 120, 210 is formed of filler-reinforced polytetrafluoroethylene (PTFE). Unfilled PTFE has a low friction coefficient, high temperature stability, and chemical resistance. Unfilled PTFE, however, has low wear resistance and may creep when subjected to a long duration load. Fillers can be added to the PTFE matrix to provide mechanical reinforcement, thereby improving its resistance to wear. These fillers may be inorganic or organic materials. Suitable organic fillers include glass fiber, carbon fiber, bronze, graphite, or the like. In particular, glass and carbon fiber fillers may be used in a PTFE seal for unlubricated compressed natural gas applications. (See, e.g., U.S. Pat. No. 8,172,557) Inorganic fillers, such as those described above, may be hard enough to cause damage to the cylinder surface during the reciprocating motion of the piston. Thus, organic fillers, which are typically softer, may be used to improve wear resistance of the unfilled PTFE while avoiding damage to the cylinder wall. Suitable organic fillers include, but are not limited to, polyamide (PA6), polyimide (PI), polyetheretherketone (PEEK), polyphenyl sulfone (PPSO2), an aromatic polyester.

A combination of two, three, or more fillers in a PTFE matrix may yield further benefits to the seal, such as increased resistance to mechanical wear. In some embodiments, the seal material is formed of PTFE filled with an organic filler and boron nitride (BN). In some embodiments, a fluorinated polymer other than PTFE may be used, such as, for example, fluorinated ethylene propylene (FEP), polychlorotrifluoroethylene (PCTFE), polyvinylidene fluoride (PVDF), polyvinyl fluoride (PVF), copolymers of ethylene and tetrafluoroethylene (ETFE), copolymers of ethylene and chlorotrifluoroethylene (ECTFE), copolymers of tetrafluoroethylene and perfluoroalkyl ethers, terpolymer of tetrafluoroethylene, hexafluoropropylene, and vinylidene fluoride (THV), terpolymer of hexafluoropropylene, tetrafluoroethylene, ethylene fluoride (HTE), or derivatives, blends, or mixtures thereof. In some embodiments, the piston seal is formed of about 70 to about 90 percent by weight of a fluorinated polymer, about 2 to about 18 percent by weight of an organic filler, and about 2 to about 18 percent by weight of boron nitride. In some embodiments, the piston seal is formed of about 75 to about 85 percent by weight of a fluorinated polymer, about 9 to about 16 percent by weight of an organic filler, and about 4 to about 12 percent by weight of boron nitride. In some embodiments, the seal material is formed of about 80 percent by weight PTFE, about 15 percent by weight of PPSO2, and about 5 percent by weight of BN.

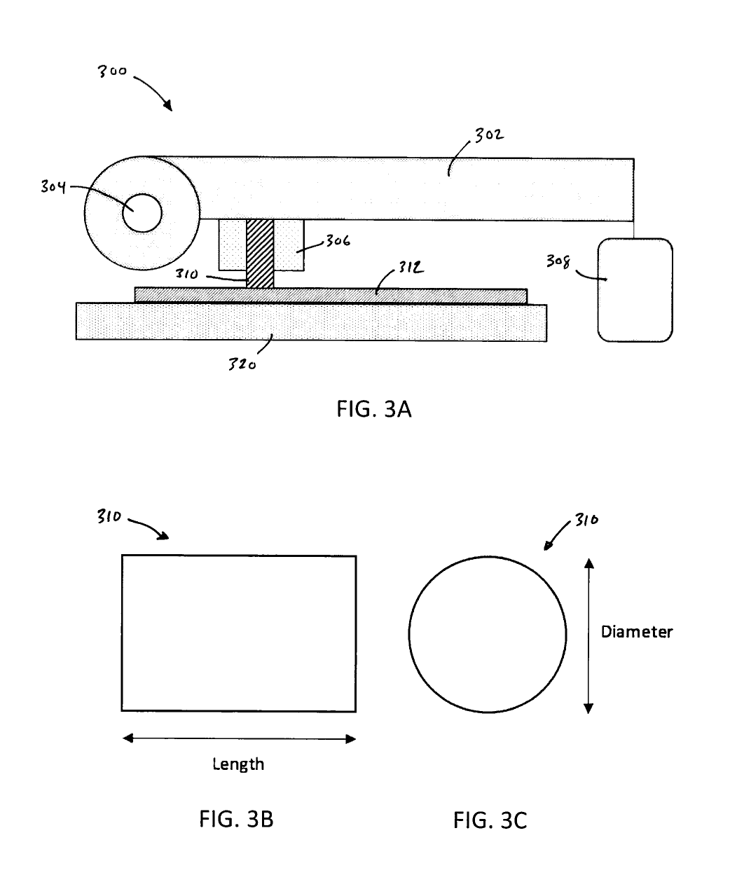

Referring now to FIGS. 3A-3C, a sliding surface wear tester 300 is shown. The sliding surface wear tester 300 simulates the operating conditions of a piston seal, such as seal 120 described above, as it repeatedly slides along the wall of a cylinder, such as cylinder 102 described above. The wear tester 300 includes a lever arm 302 that pivots at a hinge 304. A sample holder 306 holds a seal material sample 310 at a fixed distance from the hinge 304. A cylinder sample 312 is affixed to a reciprocating holder 320 that moves back and forth to simulate relative movement of a piston seal and cylinder wall. A weight 308 attached to the end of the lever 302 opposite the hinge 304 provides a downward force that presses the seal sample 310 against the cylinder sample 312, thereby simulating the sealing force resulting from a piston seal being compressed between a piston and a cylinder wall. The seal material sample 310 has a cylindrical shape and is formed of the same material as the piston seal 102. The cylinder sample 312 is a flat bar having the same material composition and surface finish of the cylinder 102 of the natural gas compressor 100. The size and shape of the seal material sample 310 may be varied to alter the size and shape of the seal contact patch formed where the seal sample 310 engages the cylinder sample 312. A conventional wear tester, such as a Taber® Reciprocating Abraser Model 5900, may also be used to test the performance of different combinations of seal and cylinder materials. During testing, the lever arm 302 remains fixed while the cylinder sample 312 and moveable holder 320 are oscillated with a displacement and frequency matching operational conditions expected in the gas compressor 100.

Seal material samples having a length of about 0.75 inches and a diameter of about 0.26 inches were tested. Cylinder wall samples were cycled at 200 cycles per minute with an approximately 1.2 inch stroke per cycle. A 5-pound weight was attached to the lever arm 302, resulting in approximately 600 pounds per square inch pressure being generated where the seal sample 310 engages the cylinder sample 312. To measure the loss of seal material, and thereby approximate the wear of a seal, the weight of the seal material sample 310 was measured at periodic time intervals over 300 hours of testing.

Stainless steel alloy and aluminum alloy were tested as cylinder wall material samples 312. Alloy 420 stainless steel hardened to a hardness of approximately 55 on the Rockwell Hardness C scale (HRC). Alloy 6061 aluminum was anodized with Sulfuric Type III Class 1 and 2 coating confirming to Mil-A-8625. In some embodiments, the anodized coating thickness is approximately 0.0015 inches. Further, the anodized aluminum coating may be applied to an aluminum surface that has been polished. The surface finish and hardness of the stainless steel and aluminum cylinder samples 312 are shown in Table 1, below.

TABLE I
Surface roughness and hardness of cylinder samples.

| | Surface | | Coating |
|---|---|---|---|
| | Roughness | Hardness | Thickness |
| Material | (Rₐ, μin.) | (HRC) | (mils) |
| Polished 6061 Aluminum | 2-4 | N/A | N/A |
| Anodized & Polished 6061 Aluminum | 8-12 | 65 | 1-2 |
| Polished 420 Stainless Steel | 2-4 | 55 | N/A |

The weight of the seal material was recorded at a certain interval and the weight retention was calculated as the fraction of the remaining weight over the initial weight. The roughness of the cylinder samples was also measured in the direction of the wear path (Align) and across the wear path (Across) to determine the wear resistance of the metal in different directions. When the wear test was completed, the surface of the cylinder samples was observed by scanning electron microscope (SEM) combined with energy dispersive X-ray spectroscopy (EDS) to determine the chemical composition of the surface of the cylinder sample. EDS can identify the elemental composition on the surface with a sampling depth of 1-2 microns. The elemental distribution can also be mapped using this technique.

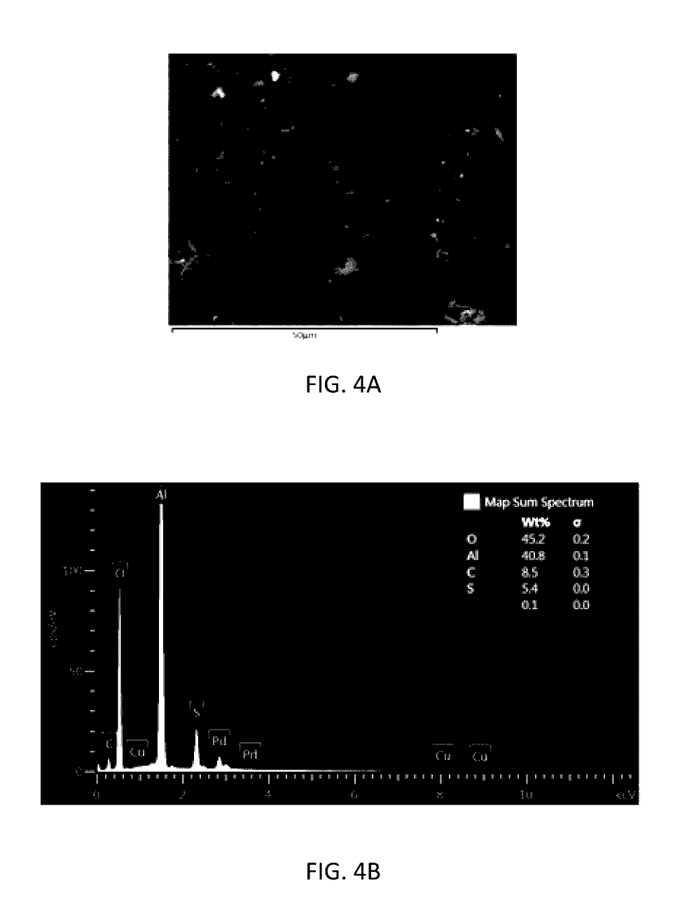

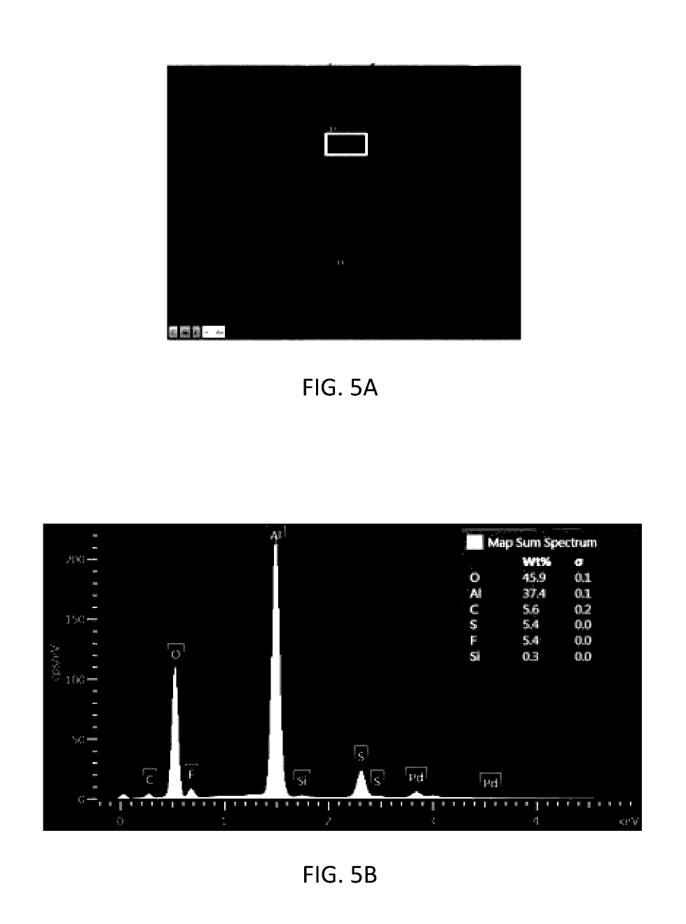

Referring now to FIGS. 4A-7B, SEM and EDS analyses of the cylinder samples after testing are shown. The SEM and EDS data show that a greater amount of seal material transferred to the anodized aluminum as compared to the stainless steel. The rectangular boxes in the SEM images, such as that shown in FIG. 5A, indicate the area of the material that is analyzed using EDS. PPSO2 filled PTFE seal material was used during testing.

FIG. 4A shows a scanning electron microscope (SEM) image of the surface of the pristine anodized aluminum test bar (i.e., the aluminum test bar before wear testing was conducted). FIG. 4B shows the primary composition of the pristine anodized aluminum surface, that is, alumina (Al₂O₃) and aluminum sulfate (Al₂S₃).

FIG. 5A shows a SEM image of the transfer film formed by the filled PTFE seal material flaking off onto the anodized aluminum sample. FIG. 5B shows the composition of the transfer film created on the surface of the anodized aluminum sample. As the composition of PTFE is a fluorine based material, the transfer of elemental fluorine to the substrate surface is taken as the relative concentration of PTFE in the transfer film. As indicated in FIG. 5B, the fluorine concentration was 5.4 percent by weight.

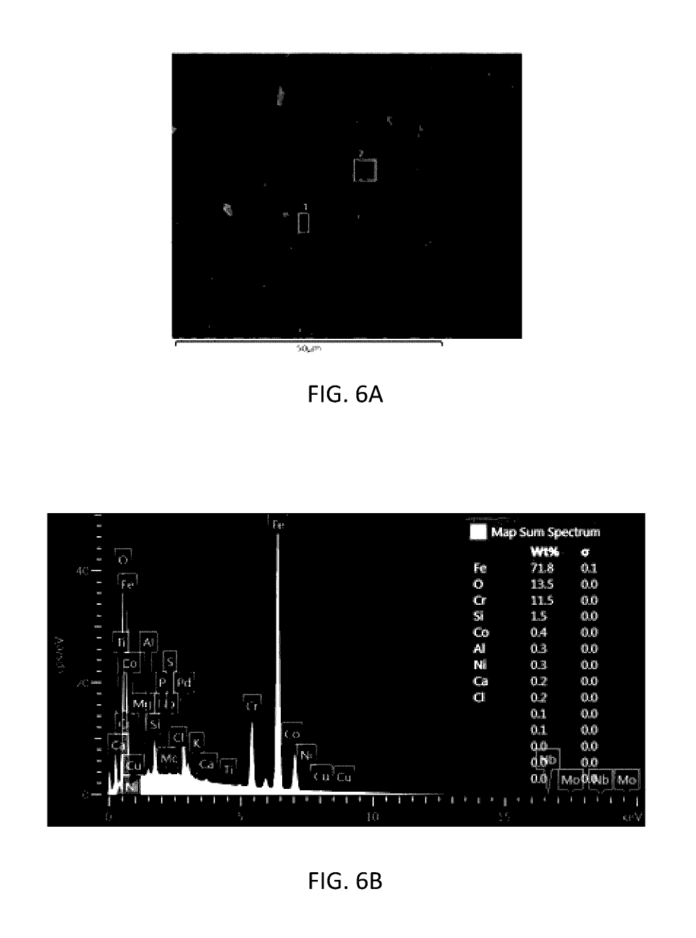

FIG. 6A shows the SEM image of the surface of the pristine stainless steel test sample. FIG. 6B shows the composition of the stainless steel test sample includes iron (Fe), oxygen (O), and chromium (Cr).

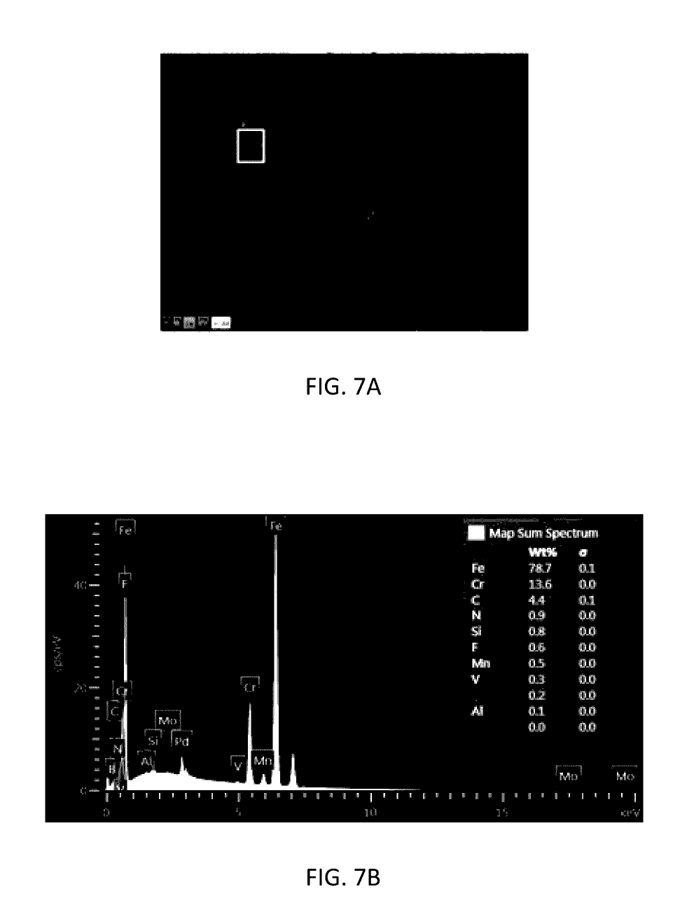

FIG. 7A shows a SEM image of the transfer film formed by the filled PTFE seal material flaking off onto the stainless steel sample. FIG. 7B shows the composition of the transfer film created on the surface of the stainless steel sample. As indicated in FIG. 7B, the fluorine concentration was 0.6 percent by weight. The amount of fluorine on the stainless steel sample as compared to the aluminum sample indicates that less PTFE seal material was transferred to the stainless steel sample.

The surface roughness of the anodized aluminum and the stainless steel was measured before and after testing. The surface roughness of the anodized aluminum cylinder samples decreased over time, while the surface roughness of the stainless steel cylinder samples increased. For example, after 388 hours of testing, the filled PTFE seal sample running on anodized aluminum was shown to decrease surface roughness in the direction of travel (Align) from 11.63 to 3.47 μin Ra and from 12.25 to 9.47 μin Ra perpendicular to the sliding axis (Across). After 446 hours of testing, a sample of the same filled PTFE material running on a stainless steel sample was increased the surface roughness from 1.73 to 1.86 μin Ra in the direction of travel (Align) and from 2.20 to 7.43 μin Ra in the direction perpendicular to the sliding axis (Across).

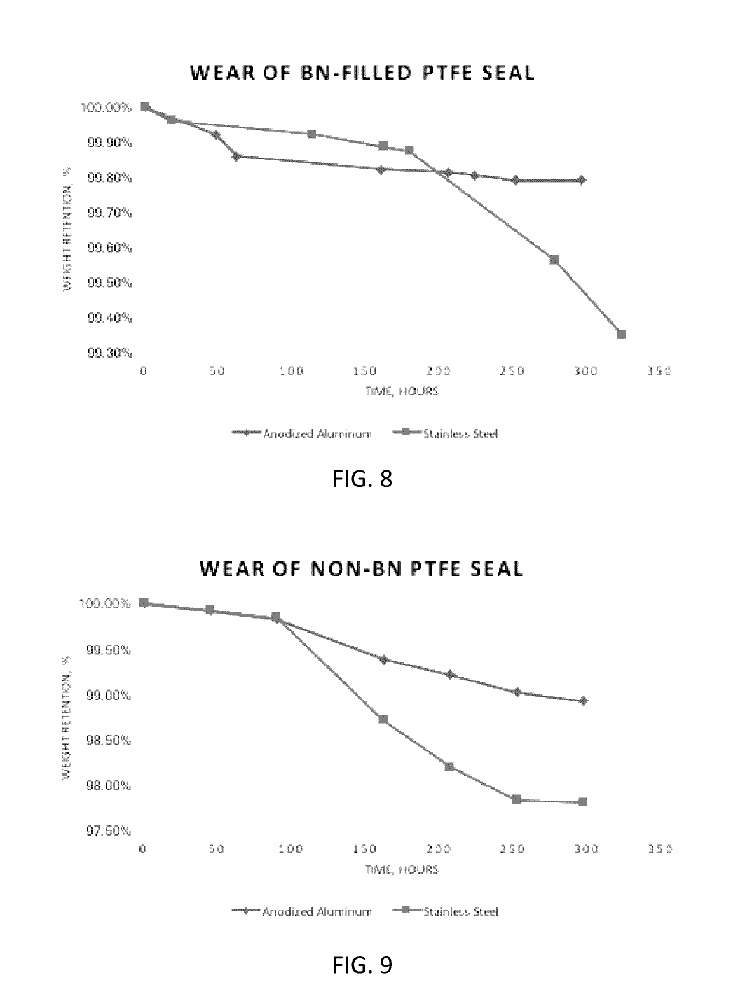

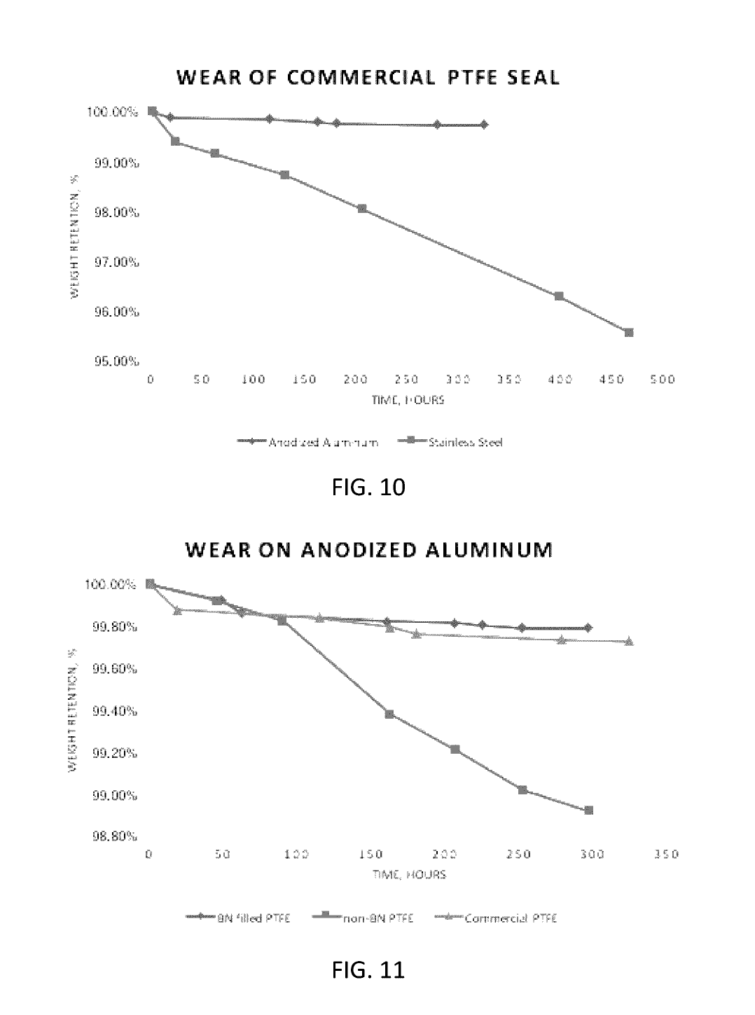

Referring now to FIGS. 8-12, data are shown indicating the weight loss of three seal material samples. The seal materials tested were BN-filled PTFE, non-BN filled PTFE, and a commercial PTFE, as shown in FIGS. 8-10, respectively. The commercial PTFE material contains carbon fiber as a filler, while the BN-filled and non-BN filled PTFE materials both included PPSO2 as an organic filler. It is noteworthy that all of the formulations described above include about 80 percent by weight PTFE. Furthermore, the only difference between the BN-filled and non-BN filled PTFE seal material is the addition of about 2 to about 18 percent by weight boron nitride. In the test results shown, the non-BN filled PTFE seal material is filled with about 20 percent by weight PPSO2. The BN-filled PTFE material includes about 15 percent by weight PPSO2 and about 5 percent by weight BN. FIG. 8 shows that the BN-filled PTFE seal wears at a slightly higher rate on the anodized aluminum than on the stainless steel after 200 hours of operation. Beyond 200 hours of testing, the BN-filled PTFE seal retains 99.79 percent of its weight when tested on the anodized aluminum, as compared to stainless steel. The data shown in FIGS. 9 and 10 reveal that, in terms of wear resistance, the seal materials tested perform consistently better on anodized aluminum than on the stainless steel over a period of 300 hours. In other words, applicants have discovered that anodized aluminum results in less seal material loss over time despite its surface being initially rougher than that of the stainless steel samples. While not wishing to be bound by theory, the rougher surface of the anodized aluminum is believed to facilitate the transfer of seal material to the cylinder wall, thereby quickly forming a more robust transfer layer than that formed on the stainless steel. These findings are corroborated by the evidence of transfer layer as shown in the SEM and EDS analyses discussed above and shown in FIGS. 4A-7B.

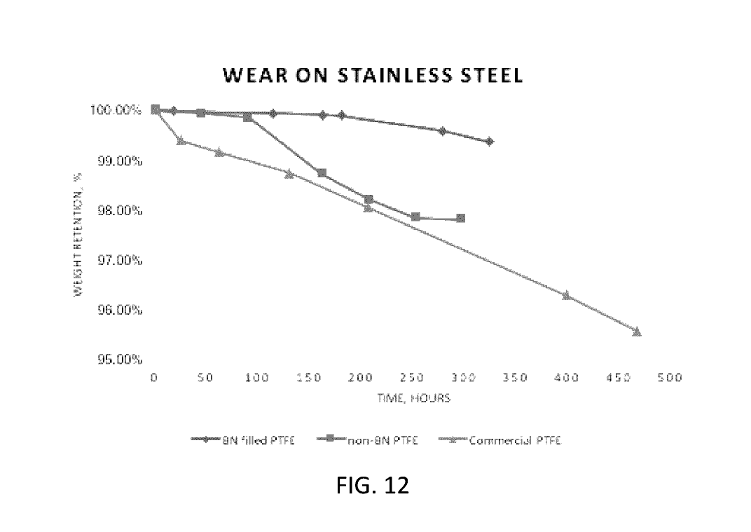

FIGS. 11 and 12 compare the weight loss of the three seal materials above when tested on the same cylinder material sample, i.e., stainless steel or aluminum. As can be seen from the charts, the BN-filled PTFE seals retain their weight better than the other seal materials on both the anodized aluminum and stainless steel tests than the other seal materials. In other words, BN-filled PTFE seals perform consistently well regardless of the cylinder wall material.

Boron nitride (BN) is a compound of boron and nitrogen with different crystalline forms. The hexagonal polymorph (known as h-BN) is analogous to graphite, which has a layered structure and is often used as a lubricant and an additive in cosmetics. While not wishing to be bound by theory, it is believed that the use of h-BN as a filler in the PTFE seal material gives the seal material a lubricous trait, thereby improving its resistance to wear.

While various inventive aspects, concepts and features of the disclosures may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts and features of the disclosures—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present application even if such embodiments are not expressly disclosed herein. Additionally, even though some features, concepts or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated. Moreover, while various aspects, features and concepts may be expressly identified herein as being inventive or forming part of a disclosure, such identification is not intended to be exclusive, but rather there may be inventive aspects, concepts and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements. Also as described herein, the terms “substantially” and “about” are defined as at least close to (and includes) a given value or state (preferably within 10% of, more preferably within 1% of, and most preferably within 0.1% of).

We claim:

1. A reciprocating compressor comprising:
a compression chamber enclosed by a cylinder and a piston, wherein the piston includes a piston seal for sealing a gas in the compression chamber;
wherein the piston seal comprises:
70 to 90 percent by weight of a fluorinated polymer;
2 to 18 percent by weight of an organic filler; and
2 to 18 percent by weight of boron nitride.

2. The reciprocating compressor of claim 1, wherein the piston seal comprises:
about 80 percent by weight of polytetrafluoroethylene;
about 15 percent by weight of polyphenyl sulfone; and
about 5 percent by weight of boron nitride.

3. The reciprocating compressor of claim 1, wherein the piston seal is free of oil-based lubricants.

4. The reciprocating compressor of claim 1, wherein the fluorinated polymer comprises at least one of polytetrafluoroethylene (PTFE), fluorinated ethylene propylene (FEP), polychlorotrifluoroethylene (PCTFE), polyvinylidene fluoride (PVDF), polyvinyl fluoride (PVF), copolymers of ethylene and tetrafluoroethylene (ETFE), copolymers of ethylene and chlorotrifluoroethylene (ECTFE), copolymers of tetrafluoroethylene and perfluoroalkyl ethers, terpolymer of tetrafluoroethylene, hexafluoropropylene, and vinylidene fluoride (THV), terpolymer of hexafluoropropylene, tetrafluoroethylene, and ethylene fluoride (HTE).

5. The reciprocating compressor of claim 1, wherein the organic filler comprises at least one of polyamide (PA6), polyimide (PI), polyetheretherketone (PEEK), polyphenyl sulfone (PPSO2), and aromatic polyester.

6. The reciprocating compressor of claim 1, wherein the gas comprises natural gas.

7. The reciprocating compressor of claim 1, wherein the gas is compressed to at least 3,600 psi.

8. The reciprocating compressor of claim 1, wherein the piston seal is configured to function for at least 3,000 hours without requiring maintenance.

9. The reciprocating compressor of claim 1, wherein a temperature of the gas is −40° F. to 200° F.

10. The reciprocating compressor of claim 1, wherein the cylinder comprises at least one of alloy 420 stainless steel and alloy 6061 aluminum.

11. The reciprocating compressor of claim 1, wherein the piston comprises aluminum.

12. The reciprocating compressor of claim 11, wherein the aluminum is a 6000 series aluminum alloy, is anodized to form an anodization layer with a thickness of 0.5 to 2 mils, and has a surface roughness of 5 to 20 micro-inches.

13. A seal for a natural gas compressor, the seal comprising:
70 to 90 percent by weight of a fluorinated polymer;
2 to 18 percent by weight of an organic filler; and
2 to 18 percent by weight of boron nitride.

14. The seal of claim 13, wherein the piston seal comprises:
about 80 percent by weight of polytetrafluoroethylene;
about 15 percent by weight of polyphenyl sulfone; and
about 5 percent by weight of boron nitride.

15. The seal of claim 13, wherein the fluorinated polymer comprises at least one of polytetrafluoroethylene (PTFE), fluorinated ethylene propylene (FEP), polychlorotrifluoroethylene (PCTFE), polyvinylidene fluoride (PVDF), polyvinyl fluoride (PVF), copolymers of ethylene and tetrafluoroethylene (ETFE), copolymers of ethylene and chlorotrifluoroethylene (ECTFE), copolymers of tetrafluoroethylene and perfluoroalkyl ethers, terpolymer of tetrafluoroethylene, hexafluoropropylene, and vinylidene fluoride (THV), terpolymer of hexafluoropropylene, tetrafluoroethylene, and ethylene fluoride (HTE).

16. The seal of claim 13, wherein the organic filler comprises at least one of polyamide (PA6), polyimide (PI), polyetheretherketone (PEEK), polyphenyl sulfone (PPSO2), and aromatic polyester.

17. A seal material consisting essentially of:
70 to 90 percent by weight of a fluorinated polymer;
2 to 18 percent by weight of an organic filler; and
2 to 18 percent by weight of boron nitride.

18. The seal material of claim 17, wherein the seal material consists essentially of:
about 80 percent by weight of polytetrafluoroethylene;
about 15 percent by weight of polyphenyl sulfone; and
about 5 percent by weight of boron nitride.

19. The seal material of claim 17, wherein the fluorinated polymer comprises at least one of polytetrafluoroethylene (PTFE), fluorinated ethylene propylene (FEP), polychlorotrifluoroethylene (PCTFE), polyvinylidene fluoride (PVDF), polyvinyl fluoride (PVF), copolymers of ethylene and tetrafluoroethylene (ETFE), copolymers of ethylene and chlorotrifluoroethylene (ECTFE), copolymers of tetrafluoroethylene and perfluoroalkyl ethers, terpolymer of tetrafluoroethylene, hexafluoropropylene, and vinylidene fluoride (THV), terpolymer of hexafluoropropylene, tetrafluoroethylene, and ethylene fluoride (HTE).

20. The seal of claim 17, wherein the organic filler comprises at least one of polyamide (PA6), polyimide (PI), polyetheretherketone (PEEK), polyphenyl sulfone (PPSO2), and aromatic polyester.
